(19) United States
(12) Patent Application Publication
(10) Pub. No.: US 2016/0148336 A1
(43) Pub. Date: May 26, 2016

(54) DATA COMMUNICATION DEVICE AND DATA COMMUNICATION SYSTEM

(71) Applicant: Japan Display Inc., Minato-ku (JP)

(72) Inventor: Kenichi OKUDA, Tokyo (JP)

(73) Assignee: Japan Display Inc., Minato-ku (JP)

(21) Appl. No.: 14/927,875

(22) Filed: Oct. 30, 2015

(30) Foreign Application Priority Data
Nov. 26, 2014 (JP) 2014-238747

(51) Int. Cl. G06T 1/20

(52) U.S. Cl. CPC G06T 1/20; G06T 2200/28

(57) ABSTRACT

According to one embodiment, terminals includes a first terminal to which a serial clock is input, a second terminal through which first data is received in synchronism with the serial clock, and a third terminal which outputs data to an external device. A decoder receives and analyzes the first data. The register stores the above received first data. A memory temporarily stores the first data, and outputs the temporarily stored first data in synchronism with second data. A switch selects one of transmission of the first data output from the memory to the third terminal and transmission of the data read from the register to the third terminal for checking.

### CROSS-REFERENCE TO RELATED APPLICATIONS

This application is based upon and claims the benefit of priority from Japanese Patent Application No. 2014-238747, filed Nov. 26, 2014, the entire contents of which are incorporated herein by reference.

### FIELD

Embodiments described herein relate generally to a data communication device and a data communication system.

### BACKGROUND

Portable terminals such as smartphones, tablet computers and notebook computers have become widespread. A portable terminal includes a display device employing a liquid crystal element, an organic EL element or the like. The portable terminal further includes a microprocessor which outputs image data, a command, etc., and a driver which processes the command and drives a display unit. The display unit is driven by the driver to display an image corresponding to the image data.

The microprocessor transmits a command, an address, data, etc., to the driver. In a communication path between the microprocessor and the driver, a serial interface which operates in synchronism with a serial clock is provided.

In general, in transmission and reception of data, it is necessary to check whether data transmitted from a transmission side to a reception side is correctly received or not. In a serial interface used by the portable terminal, a reception side (driver) is required to have a simple structure. Thus, a conventional serial interface adopts the following method: data is transmitted in a batch of small number of bits from a transmission side (microprocessor) to a reception side (driver), and stored in a register; the transmitted and stored data is read from the register, and fed back to the transmission side (microprocessor); and the fed data is checked on a reception side (microprocessor).

Thus, in the conventional serial interface, the transmission side needs to give a read command to the register in order that the data in the register is fed back to the transmission side.

### BRIEF DESCRIPTION OF THE DRAWINGS

FIG. 1 is a block diagram showing a data configuration of a data communication device according to an embodiment.

FIG. 2 is a timing chart for explaining an example of an operation of the data communication device as shown in FIG. 1.

FIG. 3 is a flowchart for explaining an example of an operation of the data communication device as shown in FIG. 1.

FIG. 4 is a view showing another communication device to be compared with the data communication device as shown in FIG. 1.

FIG. 5 is a timing chart for explaining an example of an operation of the data communication device as shown in FIG. 4.

FIG. 6 is a view schematically showing an example of the entire configuration of a display device to which the data communication device according to the embodiment is applied.

FIG. 7 is a view showing examples of data to be handled by the display device as shown in FIG. 6.

FIG. 8 is a flowchart of an example of an operation of the display device as shown in FIG. 6.

FIG. 9 is a flowchart of another example of the operation of the display device as shown in FIG. 6.

### DETAILED DESCRIPTION

As described above, in the conventional serial interface, the transmission side needs to transmit a read command to the register in order that the data stored in the register is fed back to the transmission side.

However, in a transmission path, if an error occurs in the read command itself, for example, it is impossible to cause the data to be fed back. This error can be considered to occur due to, for example, noise made externally. In addition, transmission of the above read command for reading the data of the register causes a time loss, and is thus disadvantageous to high-speed processing.

In general, according to one embodiment, as an object, there are provided a data communication device and a data communication system, which enable data to be easily fed from a reception side back to a transmission side without a specific read command to feed the data from the reception side back to the transmission side, and thus contribute to the achievement of high-speed processing.

According to one embodiment, terminals include a first terminal to which a serial clock is input, a second terminal through which input data is received in synchronism with the serial clock, and a third terminal through which output data is output to an external device. A decoder receives and analyzes first input data from the second terminal. The register stores the received first input data if the first input data is to be written to the register. A memory temporarily stores the first input data, and outputs the temporarily stored data in synchronism with second input data from the second terminal. A switch selects one of transmission of the temporarily stored data output from the memory to the third terminal and transmission of the registered data read from the register to the third terminal.

Embodiments will further be described with reference to the drawings.

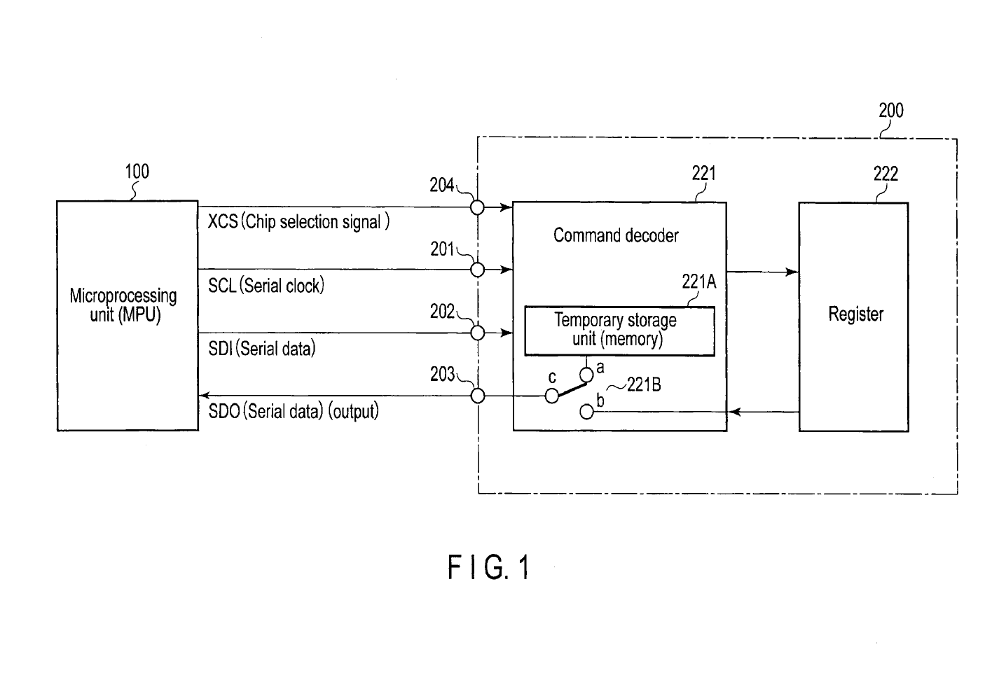

FIG. 1 shows an embodiment. In the embodiment, a microprocessing unit (MPU) 100 is connected to a receiver 200. The receiver 200 is, for example, an integrated circuit (IC) chip, and the MPU 100 is incorporated in, for example, an external device.

The receiver 200 is used as an interface in a driving IC chip which drives, for example, a display device of a portable terminal. Furthermore, the MPU 100 can be used as, for example, an application processor provided in the portable terminal.

The receiver 200 includes a first terminal 201, a second terminal 202, a third terminal 203 and a fourth terminal 204. To the fourth terminal 204, a chip select signal XCS for selecting the receiver 200 is supplied from the MPU 100. To the first terminal 201, a serial clock CSL for data transmission is supplied from the MPU 100. To the second terminal 202, serial data SDI is supplied in a predetermined transmission batch from the MPU 100. To the third terminal 203, serial data SDO can be output. The serial data SDO is input to the MPU 100.

The above predetermined transmission batch, is for example, a batch of serial 9 bits. However, the transmission batch is not limited to the batch of serial bits. For example, a batch of parallel bits may be applied. Also, the number of bits is not limited. For example, 4-bit parallel data may be transmitted in a batch of 32 bits or 36 bits.

The receiver 200 includes a command decoder 221 connected to the first terminal 201 to the fourth terminal 204. If the command decoder 221 is given a command, it analyzes the command, and executes an operation associated with the command. The command will be explained later.

The command decoder 221 includes a memory 221A used as a temporary storage unit. The memory 221A can temporarily store data input from the second terminal 202. If a subsequent period or a subsequent cycle for transmitting data unit starts, old data i.e., the temporarily stored data in the memory 221A is read, while new data which is newly transmitted is temporarily stored in the memory. The old data read from the memory 221A is output to the third terminal 203 through terminals a and c of a switch 221B. The read data, which is serial data, is fed back to the MPU 100. It should be noted that the switch 221B is formed of a semiconductor, and is a switch which can be logically controlled.

The command decoder 221 can receive command data and data as serial data from the second terminal 202. Those data are data to be recognized by the command decoder 221, data to be stored in a register 222, the address indicating an area for storing the data into the register 222, or the like.

The command decoder 221 recognizes that a first bit of a batch of predetermined transmission bits (e.g., 9 bits) is “0” or “1” as command data, for example. To be more specific, if the command data is “1”, the command decoder 221 interprets that the remaining bits (8 bits in the above case) are register data to be written to the register 222. On the other hand, if the command data is “0”, the command decoder 221 interprets that the remaining bits are address data indicating the address of an area in the register 222. It should be noted that the command data is not limited to the above first bit. For example, a plurality of bits may be used as the command data; i.e., the command may be identified based on those bits.

Furthermore, if address data regarding the register 222 is input, there is a case where the command decoder 221 interprets that the address data is a command to read data written to the register 222. Whether this determination is made or not depends on the contents of the address data. If determining the address data as such a command, the command decoder 221 reads data written to the register 222 in, for example, the preceding period (or cycle), i.e., the last period (or cycle) or the last period but one (or the last cycle but one). Also, at this time, the command decoder 221 causes the terminals b and c of the switch 221B to be connected to each other, thereby allowing the data read from the register 222 to be output to the third terminal 203.

Note, the second terminal 202 receives input data, the input data includes the input first data and input second data which are received in a different period, respectively. That is, the second terminal 202 receives two or more input data in a different period, respectively.

In the description, the data output from the third terminal 203 may be called output data. Data stored in the temporary storage unit (memory) 221A may be called the temporarily stored data. Data registered in the register 222 may be called registered data.

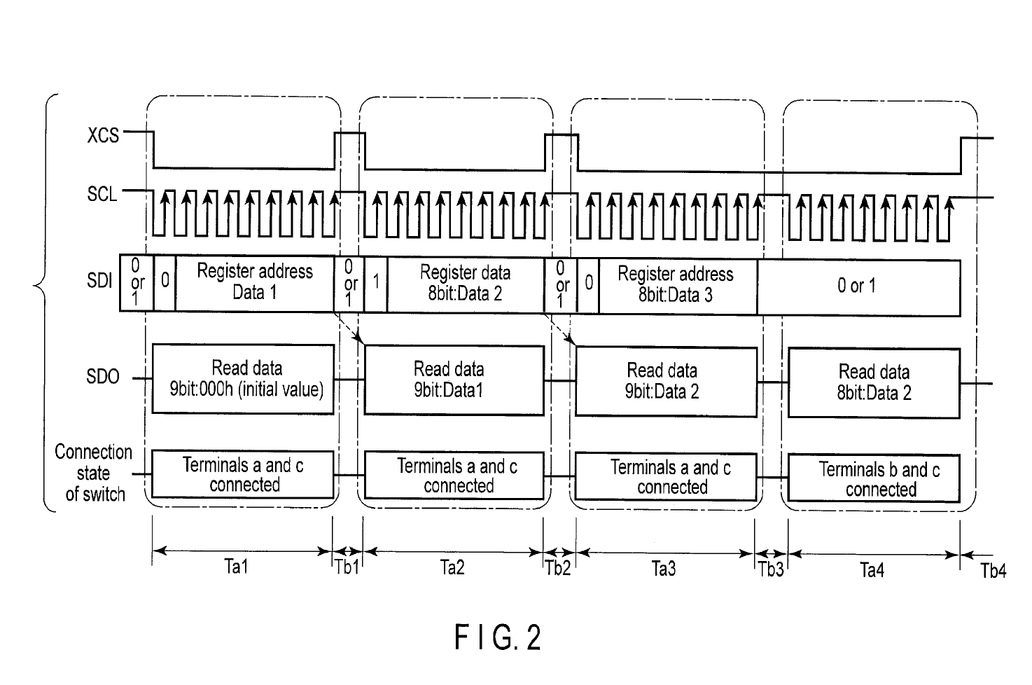

FIG. 2 is a timing chart for explaining an example of an operation of the data communication device as shown in FIG. 1. To be more specific, it shows the chip select signal XCS, the serial clock CSL, the serial data SDI and the serial data SDO output from the third terminal 203. Also, it shows a connection state of the switch 221B. To be more specific, if the terminals a and c of the switch 221B are connected to each other, data is written to the memory 221A, and data stored in the memory 221A is also read. Then, the read data is output to the third terminal 203. In this case, the read data is, for example, 9-bit data including command data. On the other hand, if the terminals b and c are connected to each other, data read from the register 222 is output to the third terminal 203. In this case, the read data is, for example, 8-bit data not including the command data. Referring to FIG. 2, in periods Ta1, Ta2, Ta3 and Ta4, the serial clock is in the ON state, and in periods Tb1, Tb2, Tb3 and Tb4, the serial clock is in the OFF state. Further, when the chip select signal XCS is, for example, at low level, the receiver 200 is selected. FIG. 2 shows four select periods (or four cycles) which are determined as predetermined transmission units.

Referring to FIG. 2, in the first period (or the first cycle), command data of serial data is “0”, and remaining 8 bits thereof are address Data1. That is, Data1 is specified as the address of an area in the register 222. Also, in the first period (or cycle), since the terminals a and c are connected to each other, the initial value 000h is read and output from the memory 221A, and also the command data “0” of the serial data (9 bits in this case) and the data Data1 are stored in the memory 221A. In the second period (or cycle), command data of serial data is “1”, and remaining 8 bits thereof are data Data2. Therefore, in accordance with the serial data of the first and second periods (or cycles), a command to write the data Data2 at the address indicated by the address Data1 is given, and the data Data2 is written to the register except the command data “1”. In addition, in the second period (or cycle), since the terminals a and c are connected to each other, the serial data in the first period (or cycle) which is previously stored in the memory 221A is read and output, and the data Data2 and the command data “1” of the serial data (9 bits in this case) in the second cycle are stored in the memory 221A.

In the third period (or cycle), command data of serial data is “0”, and remaining 8 bits thereof indicate register address Data3. Also, the data of the serial data in the third period (or cycle) is continuation of 1 or 0 (for example 000000000 or 111111111). In such a case, the command decoder 221 interprets the Data3 as a command to read data, for example, at the address written in the preceding period (or cycle) (i.e., the second period (or cycle). Furthermore, in the third period (or cycle), since the terminals a and c are connected to each other, the serial data in the second period (or cycle) which is previously stored in the memory 221A is read and output therefrom, and in addition, the serial data (9 bits in this case) in the third period (or cycle), which has the command data “0” and the data Data3, are stored in the memory 221A. In the fourth period (or cycle), the command decoder 221 executes processing for reading from the register 222, the data Data2 written thereto in the second period (or cycle). At this time, the command decoder 221 causes the terminals b and c of the switch 221B to be connected to each other, and also causes the data read from the register 222 to be output to the third terminal 203. It should be noted that since the switch 221B is switched to connect the terminals b and c to each other, the data stored in the memory 221A (the serial data in the third period in this case) is maintained.

In the above data communication device, in a chip select state, when 9-bit data is input to the command decoder 221 in synchronism with a serial clock, data temporarily stored in the memory 221A in a previous period is read therefrom, and fed back to the MPU 100. However, in the first period (initial period or cycle), since the memory 221A is in a reset state, data 0 is read from the memory 221A.

The receiver 200 includes the memory 221A and the switch 221B. Thus, the MPU 100 can receive data which it transmitted in, for example, the preceding period, without giving a specific read command, as return data in the present period, i.e., the period (or cycle) subsequent to the preceding period. In the embodiment, in an example shown in FIG. 2, when data is returned from the memory 221A through the terminals a and c and the terminal 203, it is data having 9 bits which correspond to the total value of command data (1 bit) and address data or register data (8 bits); and when data is from the register 222 through the terminals b and c and the terminal 203, it is data having 8 bits as indicated with respect to period Ta4.

According to above mentioned communication system, when the subsequent period ends, it is possible to detect whether the transmitted data is correct or not. To be more specific, the MPU 100 holds the transmitted data until the subsequent period (or cycle), and compares the transmitted data with the return data, thereby effecting the above detection.

As a result, the MPU 100 needs not to send a read command each time after it transmits unit of data, thus, the load on the MPU 100 is reduced. Also, it is possible to detect early whether the transmitted data is correct or not. In a method required to send the read command, if an error is made in the read command itself, it is hard to determine whether the error is made in transmitted data or the read command. However, in the embodiment, it is not necessary to determine whether an error occurs in a read command or not.

Furthermore, the switch 221B can be used at the time of reading data stored in the register 222. Therefore, even if an application of the MPU 100 is an application for repeating transmission of address data indicating the address of an area in a register, transmission of data to be written at the indicated address, issuance of a read command to read the written data, and reception and checking of the read data, as in the conventional data communication device, the receiver 200 can be used. That is, the receiver 200 is useful when the conventional MPU is used.

It should be noted that it is explained above that when the register address Data3 is input to the command decoder 221, the command decoder 221 reads data written to the register 222 in the preceding period, i.e., the period immediately preceding to the present period. However, the configuration of the command decoder 221 is not limited to the above configuration. That is, the command decoder 221 may be configured as follows. When the register address Data3 is input to the command decoder 221, the read data from the register 222 may be data written in a period which is before of a plural period.

Also, it is explained above that data read from the memory 221A and fed back to the MPU 100 is data written to the memory 221A in a one-previous period, i.e., a period just precedent to the present period. However, the data to be fed back to the MPU 100 is not limited to such data; that is, data written to the memory 221A in a period precedent to the present period by a number of periods may be fed back to the MPU 100.

To be more specific, it may be set that the memory 221A includes partial memories 221Aa and 221Ab; in the first period, first serial data is stored in partial memory 221Aa; in the second period, second serial data is stored in partial memory 221Ab; and in the third period, the first serial data is read and output from partial memory 221Aa.

Furthermore, although only one memory 221A is shown and described above, a plurality of memories 221A may be provided. Then, data in an arbitrary one of the memories 221A may be selected by a switch, and be returned as return data.

It should be noted that in the embodiment, in the fourth period, an operation is performed in response to a data read command. To be more specific, in the case where data stored in the register is output therefrom in response to a read command, the number of bits in the data stored in the register is the number of bits in serial data not including command data (i.e., in the above case, it is 8). On the other hand, the data stored in the memory 221A is serial data including command data (the serial data has 9 bits). Thus, it is shown that period Ta4 is shorter than each of periods Ta1 to T1. However, setting of the periods is not limited to the above setting.

In order that period Ta4 be equal to each of periods Ta1 to Ta3, in the case where the MPU 100 gives a read command to read data from the register, a blank period may be provided before or after outputting of the data from the register.

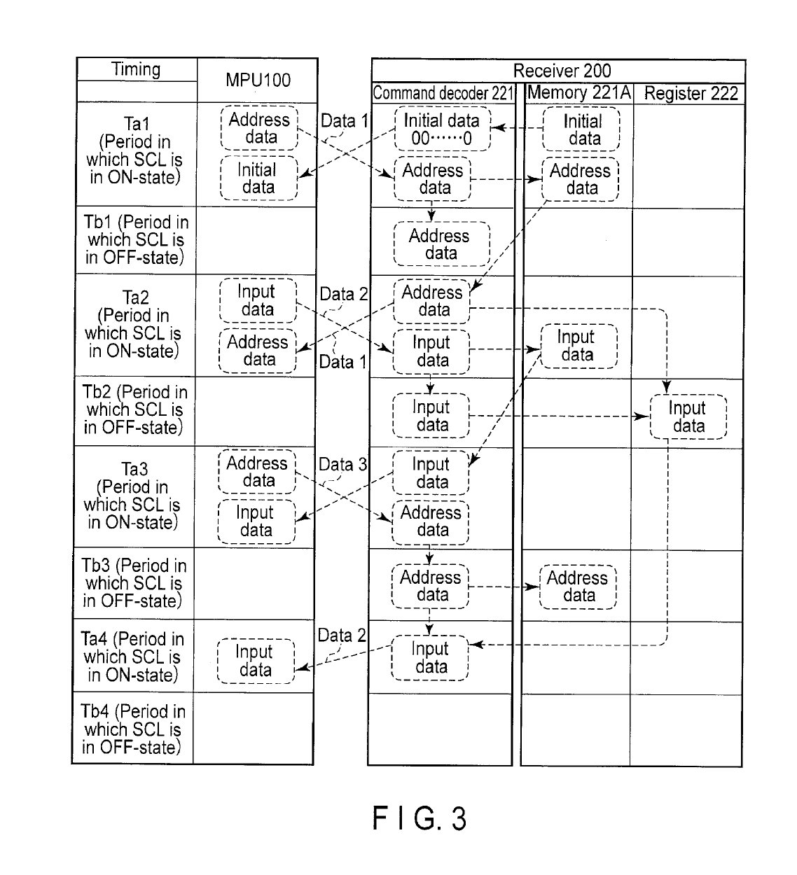

FIG. 3 is a flowchart showing transmission and reception of data between the MPU 100 and the receiver 200. In period Ta1, a serial clock is in the ON state, and address data Data1 is transmitted from the MPU 100 to the receiver 200. Also, the MPU 100 receives initial data 000 . . . 0, which is read from the memory 221A of the receiver 200. In period Tb1 subsequent to period Ta1, the serial clock is in the OFF state, and in period Ta2 subsequent to period Tb1, a serial clock is in the ON state, and input data Data2 is transmitted from the MPU 100 to the receiver 200. Also, the MPU 100 receives return address data Data1 which is read from the memory 221A and is fed back. Furthermore, input data Data2 transmitted from the MPU 100 to the receiver 200 is stored in the register 222, except command data (the address of an area for storing the input data Data2 is indicated by the above address data Data1). At this time, in the switch 221B, the terminals a and c are connected to each other, data is written to the memory 221A, and data stored in the memory 221A is read. Then, the read data is returned to the MPU 100 through the third terminal 203. In this case, the read data is, for example, 9-bit data including command data.

The MPU 100 can check in units of one bit whether or not the return address data Data1 which is fed back is identical to the address data Data1 which the MPU 100 transmitted previously.

In period Tb2, the serial clock is in the OFF state, and in period Ta3 subsequent to period Tb2, the serial clock is ON state, and address data Data3 is transmitted from the MPU 100 to the receiver 200. Also, the MPU 100 receives return input data Data2 which is read from the memory 221A, and is fed back. Then, the MPU 100 can check in units of one bit whether or not the fed-back return input data Data2 is identical to the input Data2 which the MPU 100 transmitted previously.

Suppose the address data Data3 is a command to read from the register 222 the input data Data2 transmitted in period Ta2. In this case, the command decoder 221 switches the connection state of the switch 221B to cause the terminals b and c to be connected to each other, and reads return input data Data2 from the register 222 as shown period Tb4. The read return input data Data2 is transmitted to the MPU 100, when the terminals a and b are connected to each other, the data read from the register 222 is returned to the MPU 100 through the third terminal 203. In this case, the read data is, for example, 8-bit data not including the command data.

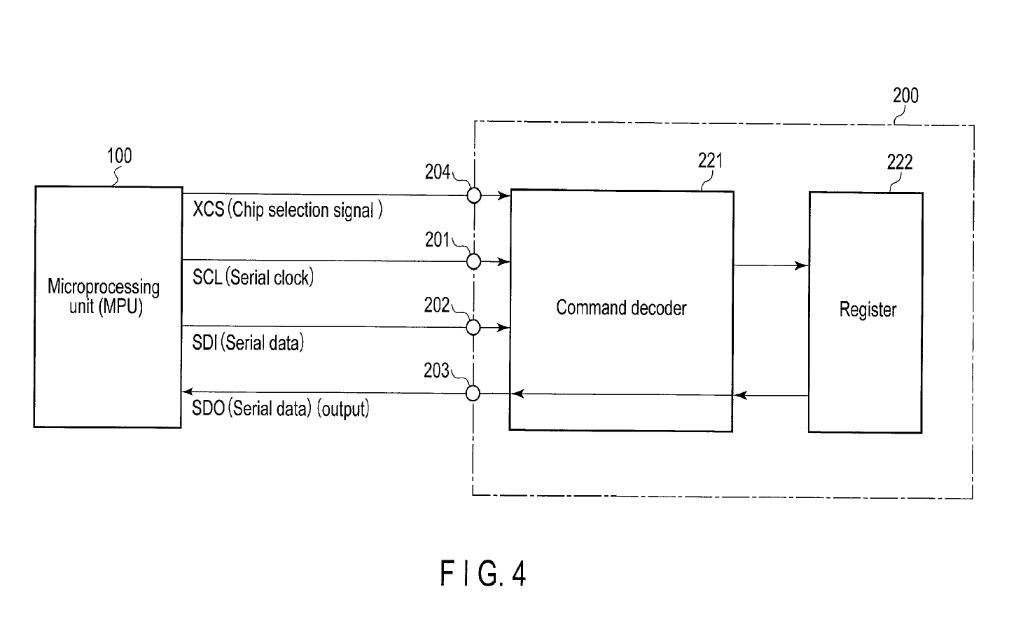

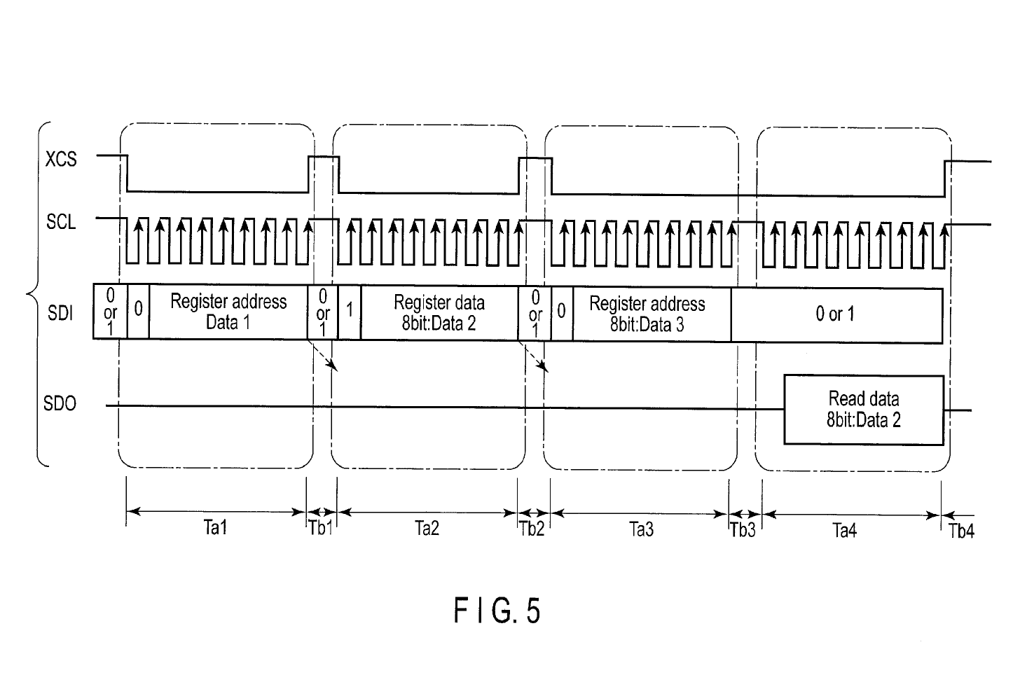

FIG. 4 shows an example of a data communication device in which the memory 221A and the switch 221B are omitted from the data communication device as shown in FIG. 1; and FIG. 5 is a timing chart of an operation of the data communication device as shown in FIG. 4.

In the data communication device as shown in FIG. 4, in the case of detecting whether data transmitted from the MPU 100 to the receiver 200 is correct or not, this detection is performed in the following manner:

The MPU 100 transmits register address data Data1 in period Ta1 in which a serial clock SCL is in the ON state as shown in FIG. 5. The command decoder 221 analyzes the register address data Data1 to determine the address of an area for storage in the register 222. The MPU 100 transmits data Data2 in period Ta2 in which the serial clock SCL is in the ON state. Then, the command decoder 221 stores the data Data2 in the area in the register 222 the address of which is determined by analyzing the register address data Data1.

Then, in order to confirm whether the stored data Data2 is correct or not, the MPU 100 transmits specific register address Data3 as a command. The command decoder 221 analyzes the register address Data3, reads the above data Data2 from the register 222, and outputs the read data Data2 as serial data to the third terminal 203. The MPU 100 checks whether the data Data2 has a correct value or not.

In the above method, in order to check whether the transmitted data received by the receiver 200 is correct or nor, the MPU 100 transmits a command to read data from the register 222. If the data Data2 is not correct or it is not returned, the MPU 100 cannot determine whether an error is made in the above data Data2 or the register address Data3 does not function as a command. Furthermore, the MPU 100 must transmit a command (register address Data3) to read data from the register 222, for data check, and thus cannot check data in real time.

As compared with the technique described above with reference to FIGS. 4 and 5, in the structure as shown in FIG. 1, the MPU 100 does not need to transmit a read command to read data from the register, and the load on the MPU 100 can be reduced. Thus, the MPU 100 does not need to determine whether a read command is correct or not. Also, it is possible to detect at an early stage whether the transmitted data is correct or not.

According to above processing, if data to be registered in the register 222 is generated by editing of received data in the decoder 221, the received data to be edited is checked before editing data is generated or registered in the register 222. Therefore, unstable data or data containing a problem is prevented to be registered in the register 222.

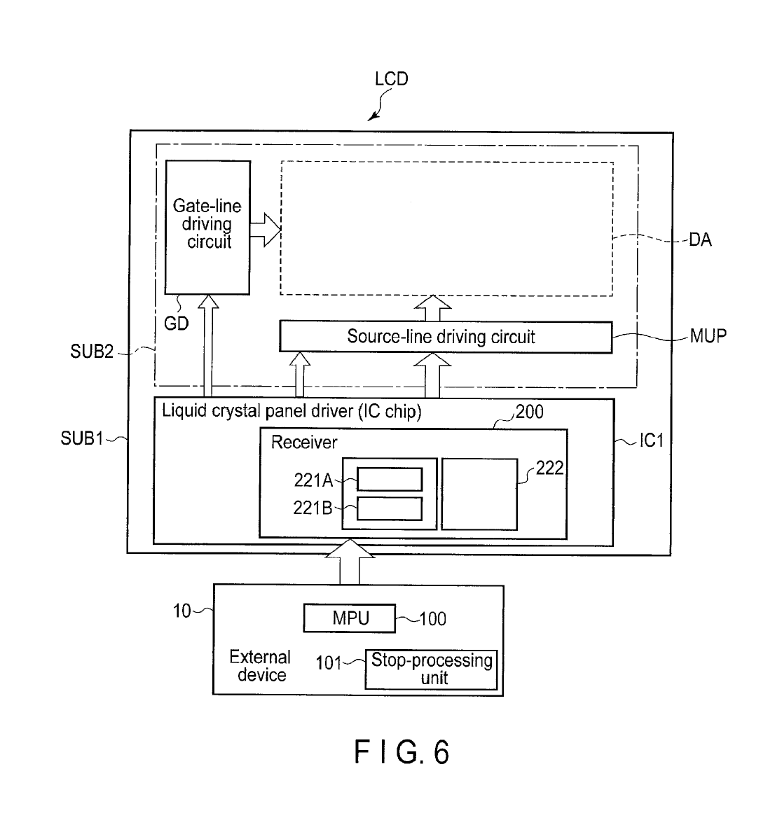

FIG. 6 is a view schematically showing the configuration of a display device to which the embodiment is applied. Referring to FIG. 6, a liquid crystal display panel LCD comprises a first substrate SUB1, a second substrate SUB2 located opposite to the first substrate SUB1, and a liquid crystal layer formed between the first substrate SUB1 and the second substrate SUB2. The first substrate SUB1 and the second substrate SUB2 may be referred to as an array substrate and a counter-substrate, respectively. A liquid crystal panel driver IC1 which drives the liquid crystal display panel LCD is mounted on the first substrate SUB1.

The liquid crystal panel driver IC1 is connected to an external device 10 through a flexible substrate (not shown). The external device 10 includes an MPU 100, which is identical to the above MPU 100. The external device 10 supplies image data, sequence control data for use in displaying an image corresponding to the image data, etc., to the liquid crystal panel driver IC1. Furthermore, the MPU 100 of the external device 10 holds transmitted data until a subsequent period (or cycle), and compares the transmitted data with return data, to thereby detect whether the transmitted data and the return data are identical to each other or not. If the transmitted data and the return data are not identical to each other, that is, disagreement, the MPU 100 can re-transmit data. However, if such disagreement successively occurs a few times, a stop-processing unit 101 can be controlled to cause it to stop the operation of the display device, or to make the display device display an alarm notification indicating that an error occurs.

The liquid crystal panel driver IC1 includes a receiver 200 which can receive various kinds of signals supplied from the external device 10. The receiver 200 includes a command decoder 221, a memory 221A, a switch 221B, a register 222, etc.

The first substrate SUB1 includes a display area DA and a non-display area surrounding the display area DA. In the display area DA, a plurality of pixels are two-dimensionally arrayed. A gate electrode of each of the pixels is connected to an associated gate line. Also, an input electrode of each pixel is connected to an associated source line.

For example, in a left area of the non-display area surrounding the display area DA, a gate-line driving circuit GD is provided. The gate-line driving circuit GD can drive gate lines. Also, in a lower area of the non-display area, a source-line driving circuit MUP is provided (there is a case where the source-line driving circuit is referred to as a multiplexer). The source-line driving circuit MUP can output a pixel signal to source lines.

Therefore, each pixel is controlled to be selectively on and off by a select signal supplied through an associated gate line, and when being on, each pixel is supplied with a pixel signal through an associated source line.

The gate lines are selectively driven by the above gate-line driving circuit GD based on a timing signal supplied by the liquid crystal panel driver IC1. The source-line driving circuit MUP can supply a pixel signal output from the liquid crystal panel driver IC1 to source lines. In this case, the source-line driving circuit MUP can supply the pixel signal to an arbitrary source line based on a timing signal supplied from the liquid crystal panel driver IC1.

Therefore, an arbitrary pixel can be made to be selectively in a conductive state and a nonconductive state by the gate-line driving circuit GD and the source-line driving circuit MUP. Because of this control, it is possible to execute rewriting processing on a pixel signal regarding part of the display area. Needless to say, pixels in the entire display area DA can be successively subjected in units of one row of pixels to processing (display scanning processing) for writing a pixel signal.

It should be noted that in each of the receiver 200 and the MPU 100, such a data communication device as described above is provided. Data to be transmitted by the data communication device is, for example, a command (sequence control data) to set an operation sequence of the gate-line driving circuit GD or the source-line driving circuit MUP. Also, in the case where image data is transmitted from the external device 10 to the receiver 200, the data communication device can also be applied. In this case, in the embodiment, it is more preferable that parallel data be transmitted than serial data.

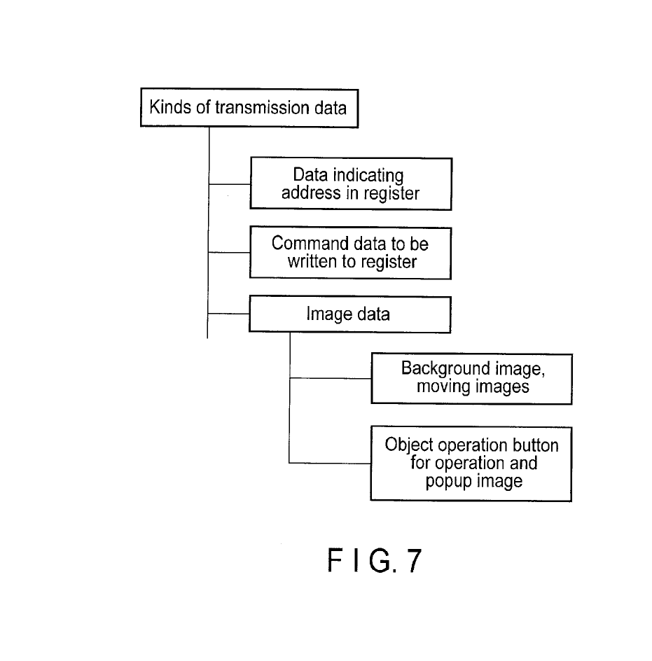

FIG. 7 shows examples of various kinds of transmission data to be handled by the display device as shown in FIG. 6. The data to be transmitted from the external device 10 to the liquid crystal panel driver IC1 are data indicating the address of an area in the register 222, command data (sequence control data) for directing the writing of data into the register 222, command data to be written into register 222, image data to be supplied from the liquid crystal panel driver IC1 to the source-line driving circuit MUP, etc. The image data are data for a background image and moving images, data on an object (operation button, popup image, etc.) to be used in an operation, etc.

In the above description, the input data received at the second terminal 202 includes two or more input data in a different period, respectively. And the first input data is address data and the second input data is data to be registered in the register 222, as an example.

However, the invention does not limited above description. The kind of data and the name of data are not limited to the above-mentioned example. The first input data and the second input data may be called the first sub data and the second sub data, for example.

Furthermore, in the above-mentioned explanation, it is explained that one kind of data (for example, address data or data which should be registered) is transmitted in one of periods. However, some kinds of data may be transmitted in one period. For example, address data and the data which should be registered may be transmitted in one of periods.

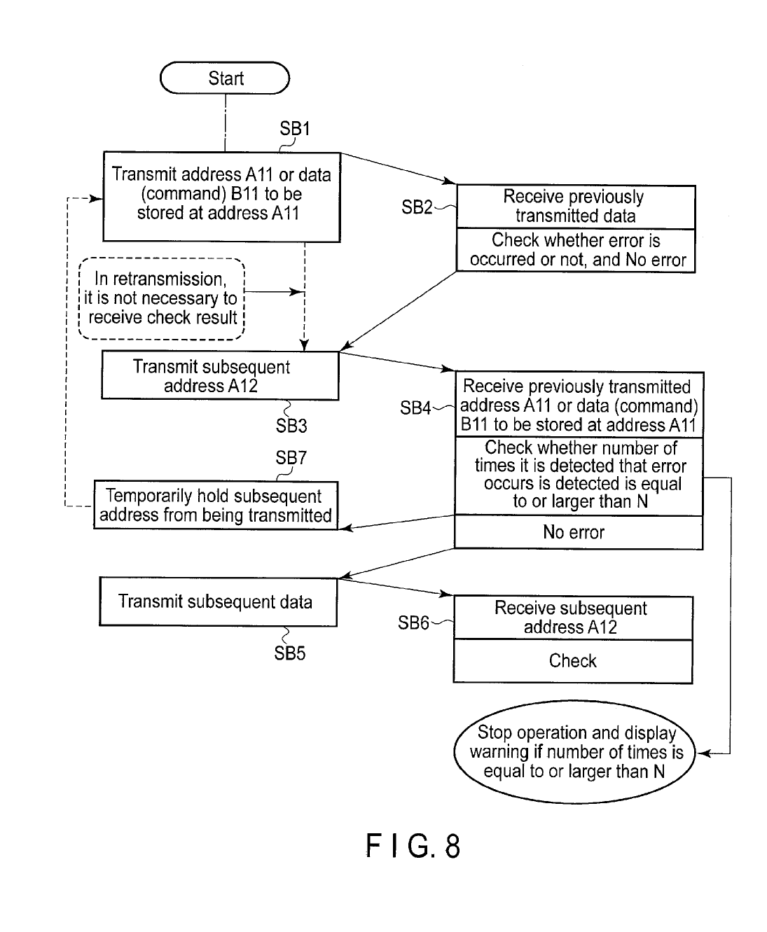

FIG. 8 is a flowchart showing an example of an operation of the MPU 100 in communication between the MPU 100 and the receiver 200.

The MPU 100 transmits address A11 or data (command) B11 to be stored at the address A11 to the receiver 200 (step SB1). At the same time as the MPU 100 transmits it, the MPU 100 receives, for example, previously transmitted data (return data) from the receiver 200. The MPU 100 checks whether the return data has an error or not (step SB2). If the return data does not have an error, the MPU 100 transmits a subsequent address, i.e., address A12, to the receiver 200 (step SB3). At the same time as the MPU 100 transmits it, the MPU 100 receives, for example, the previously transmitted address, i.e., address A11, or data (command) B11, as return data, from the receiver 200. Then, the MPU 100 checks whether the return data has an error or not (step SB4). If the return data does not have an error, the MPU 100 transmits subsequent data to the receiver 200 (step SB5). Also, the MPU 100 receives address A12 transmitted in step SB3 as return data, then the MPU 100 checks whether address A12 has an error or not (step SB6).

It should be noted, if the return data has an error in step SB4, the MPU 100 judges whether number of the error detection times against the return data is greater than or equal to N. If the number is less than N, the MPU 100 causes address A12 transmitted in step SB3 to be temporarily retains to the MPU 100 (step SB7), the step to be carried out is returned to step SB1, and processing is re-executed from step SB1. On the other hand, if in step SB4, the above number is greater than or equal to N, the MPU 100 controls the stop-processing unit 101 to stop the operation of the display device to and cause the display device to display a warning. In another example, it may be set that in step SB4, if the number of error bits is less than or equal to m, the processing proceeds to step SB5, and if the number of error bits is greater than or equal to m+1, the operation of a display device is stopped, and/or the display device is caused to display a warning.

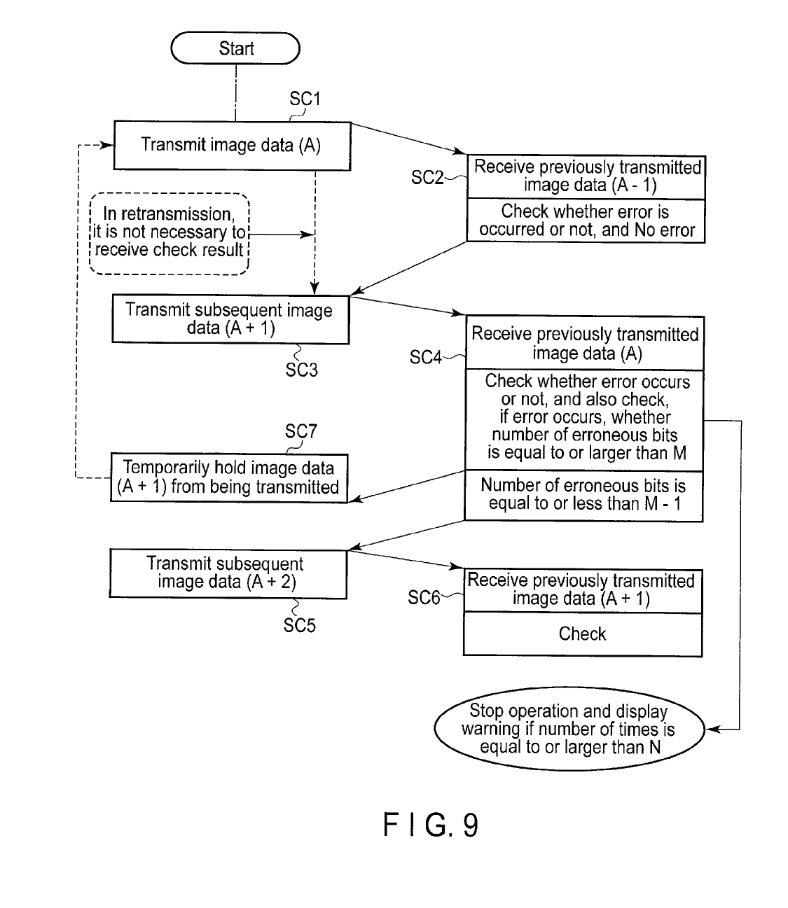

FIG. 9 is a flowchart showing another example of the operation of the MPU 100 in communication between the MPU 100 and the receiver 200.

The MPU 100 transmits image data A to the receiver 200 (step SC1). Also, at the same time as the MPU 100 transmits it, the MPU 100 receives and checks previously transmitted image data (return data). If the return data has no error, the MPU 100 transmits subsequent image data to the receiver 200 (step SC3). At the same time as the MPU 100 transmits it, the MPU 100 receives previously transmitted image data (return data), and checks it whether it has an error or not (step SC4). If the number of erroneous bits is less than or equal to M−1, subsequent image data is transmitted (step SC5). At the same time as it is transmitted, image data transmitted in step SC3 is received as return data, and checked (step SC6). On the other hand, in step SC4, if the number of erroneous bits is greater than or equal to M, image data to be transmitted in step SC3 is temporarily held in a buffer, and the step to be carried out is returned to step SC1. Also, in step SC4, if the number of erroneous bits is greater than or equal to M, the MPU 100 controls the stop-processing unit 101 to stop the operation of the display device and cause the display device to display a warning. In another example, it may be set that in step SC4, if the number of times it is detected that the number of erroneous bits is greater than or equal to a predetermined number is less than or equal to n, the processing proceeds to step SC5, and if the above number of times is greater than or equal to n+1, the operation of the display device is stopped or the display device is caused to display a warning.

As above mentioned, the embodiments have many aspects of the invention. For examples, the second terminal receives two or more input data in a different period, respectively. The input data received by the second terminal 203 may include address data, if the first data is the address data indicating an address of an area in the register, the decoder specifies the address of the area in the register, and writes the address data to the memory. Further, the input data may include first input data and second input data, and the decoder 221 writes the first input data to the memory 221A and registers the second input data to the register 222, and the memory 221A outputs the temporary stored data corresponding to the first input data during the second input data inputs to the second terminal. The second input data may includes a control signal for controlling the switch 221B. And the decoder 221 controls the switch 221B according to a control signal.

Further more, if the second input data is a specific value, the decoder 221 reads the registered data in the register 222, and controls the switch 221B to cause the register and the third terminal to be connected to each other. The input data includes a plurality of kinds of data, and the kind of the temporally stored data in the memory 221A differs from that of the registered data to be stored in the register 222. The data amount of the temporally stored data in the memory 221A differs from that of the registered data. A part of the input data is registered in the register 222.

The input data comprises identifying data (“o” or “1”) which identifies a kind of the input data and the registered data which is to be registered in the register, and the both of the identifying data and the registered data are stored in the memory. The registered data in the register 222 is used to produce a timing pulse for a driving circuit which drives a display panel.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data communication device comprising:
terminals including a first terminal to which a serial clock is input, a second terminal through which input data is received, the input data being transmitted in a predetermined batch in synchronism with the serial clock, and a third terminal through which output data is output to an external device,
a decoder which analyzes first input data received through the second terminal;
a register which stores the received first input data if the first input data is to be written to the register;
a memory which temporarily stores the received first input data, and outputs temporarily stored data in synchronism with second input data received through the second terminal; and
a switch which selects one of transmission of the temporarily stored data output from the memory to the third terminal and transmission of registered data read from the register to the third terminal.

2. The data communication device of claim 1, wherein the second terminal receives two or more input data in a different period, respectively.

3. The data communication device of claim 1, wherein the input data may include address data, if the first data is the address data indicating an address of an area in the register, the decoder specifies the address of the area in the register, and writes the address data to the memory.

4. The data communication device of claim 1, wherein the input data may include first input data and second input data, the decoder writes the first input data to the memory and registers the second input data to the register, and the memory outputs the temporary stored data corresponding to the first input data during the second input data inputs to the second terminal.

5. The data communication device of claim 1, wherein the second input data may includes a control signal for controlling the switch.

6. The data communication device of claim 1, wherein the decoder controls the switch according to a control signal.

7. The data communication device of claim 1, wherein if the second input data is a specific value, the decoder reads the registered data in the register, and controls the switch to cause the register and the third terminal to be connected to each other.

8. The data communication device of claim 1, wherein the input data includes a plurality of kinds of data, and the kind of the temporally stored data in the memory differs from that of the registered data to be stored in the register.

9. The data communication device of claim 1, wherein the data amount of the temporally stored data in the memory differs from that of the registered data.

10. The data communication device of claim 1, wherein a part of the input data is registered in the register.

11. The data communication device of claim 1, wherein the input data comprises identifying data which identifies a kind of the input data and the registered data which is to be registered in the register, and the both of the identifying data and the registered data are stored in the memory.

12. The data communication device of claim 1, wherein the registered data in the register is used to produce a timing pulse for a driving circuit which drives a display panel.

13. A data communication system comprising a micro-processing unit and a receiver to which the micro-processing unit is connected,
wherein a receiver includes:
a first terminal to which a serial clock is input, a second terminal through which input data is received, the input data being transmitted in a predetermined batch in synchronism with the serial clock, and a third terminal through which output data is output to an external device;
a decoder which analyzes the received first input data;
a register which registers the received first input data if the first input data is to be written to the register;
a memory which temporarily stores the received first input data, and outputs temporarily stored data in synchronism with second input data received through the second terminal; and
a switch which selects one of transmission of the temporarily stored data output from the memory to the third terminal and transmission of registered data read from the register to the third terminal, and
wherein the micro-processing unit includes:
an output terminal through the serial clock is output, output terminals through which the first input data and the second input data are output, and an input terminal through which the output data output through the third terminal is received, and
a processor configured to compare return data received through the third terminal with stored data corresponding to the return data to check whether the return data has an error or not.

14. The data communication system of claim 13, wherein the micro-processing unit issues an alarm if the number of times it is detected that the return data has an error is greater than or equal to a predetermined number of times.
